(19) United States
(12) Patent Application Publication
(10) Pub. No.: US 2012/0325687 A1
(43) Pub. Date: Dec. 27, 2012

(54) Modulated pH wipes

(76) Inventors: Kent Scott, Mosinee, WI (US); Craig Mortensen, Mosinee, WI (US)

(21) Appl. No.: 13/530,046

(22) Filed: Jun. 21, 2012

Related U.S. Application Data
(63) Continuation of application No. 61/499,543, filed on Jun. 21, 2011.

(51) Int. Cl. A45C 11/00; A01P 3/00; A01P 1/00; A01N 25/34; A01N 59/00

(52) U.S. Cl. 206/37; 424/411; 424/600; 424/663

(57) ABSTRACT

A low pH wipe is produced having no other buffering or modifying agents, using water only. The water has been modified by means of a reactor to produce an excess of hydronium ions to lower the pH.

### CROSS REFERENCE TO RELATED APPLICATIONS

This application claims priority from U.S. provisional application 61/499,543 filed 21 Jun. 2011; entitled “Modulated pH wipes”. The entire contents being hereby incorporated by reference and for which benefit of the priority date is claimed.

### FIELD OF THE INVENTION

The present invention relates to cleaning wipes produced by means of a carrier being impregnated with only water having a modulated pH. In particular to an antimicrobial wet wipe, having only water with no other buffering agent or chemical stabilizer, and the water being prepared by means of a reactor designed to create water having an excess of hydronium ions.

### BACKGROUND OF THE INVENTION

Water is typically found in nature at a pH of approximately 7. A pH higher than 7, typically 7 to 14 is referred to as basic. A pH lower than 7, typically 1-7, is referred to as acidic. It has been found that water having a pH of less than about 5.4 or higher than about 12 can be effective in killing bacteria, fungi, yeasts, mold, protozoan, viruses and the like.

The invention provides in one aspect an improved method for creating a low pH wipe by wetting the wipe using water from a stream with a high hydronium ion content generated by a reactor vessel such as is found in U.S. application Ser. No. 12/731,875 incorporated herein by reference.

It is therefore an object of the invention to provide a method for producing a wet wipe useful against bacteria, fungi, yeasts, mold, protozoan, and viruses.

It is therefore an object of the invention to create a wipe having an excess of hydronium ions in water with a pH between about 2.8 and 3.8.

It is another object of the invention that this wipe be prepared starting with tap water.

It is another object of the invention to incorporate agents of other chemistries from the group of; scents, perfumes, surfactants, buffers, solvents.

It is another object of the invention to provide a low pH wipe having a fresh lemon scent.

### SUMMARY OF THE INVENTION

### BRIEF DESCRIPTION OF THE DRAWINGS

No drawings are contained in this application.

### DETAILED DESCRIPTION

The preferred to target the pH at approximately 3.0 with a range of 2.8 to 3.8 being acceptable for the present purposes of the invention. It is preferred, using the apparatus of the '875 application, that there be some ionization in the water. It has been found, for example, that a tap water having some mineral content is preferred to de-ionized water or even distilled water. In the case of tap water down to about 80 mg/L calcium carbonate can be tolerated. The balance comes between having sufficient ions for production of the low pH and too high which can cause scaling of the equipment.

In the case of de-ionized water, it has been found that the inclusion of some salt helps the process. It is believed that it may be the Chlorine ion, or possibly the fact that the resistivity of the water is lowered to the point that it aids the formation of hydronium ions. Therefore water from a public water system is typically preferred.

Standard foil or foil laminated film packages with a polyethylene terephthatlate (PET) base such as white (3091WF) or clear (3091F) are suitable for packaging purposes.

It is anticipated that a packet quantity of 24 sized 12 by 21 cm non woven polyester or cellulose polyester blend wipes would require approximately 80 gm of low pH water to be effective for the purposes disclosed.

Other chemistries may be added such as surfactants, solvents, scents and perfumes to create a more pleasing experience to the user.

### CONCLUSION, RAMIFICATIONS, AND SCOPE

Although the present invention has been described in detail, those skilled in the art will understand that various changes, substitutions, and alterations herein may be made without departing from the spirit and scope of the invention in its broadest form. The invention is not considered limited to the example chosen for purposes of disclosure, and covers all changes and modifications which do not constitute departures from the true spirit and scope of this invention.

For example, although the foregoing refers to tap water, it is contemplated that a de-ionized water with a quantity of returned ionic content can be used.

Having thus described the invention, what is desired to be protected by Letters Patent is presented in the subsequent appended claims.

We claim:

1. A method for providing a wet wipe useful against bacteria, fungi, yeasts, mold, protozoan, and viruses comprising:
(i) providing a fibrous sheet of material;
(ii) wetting the sheet with a low pH water, said water being provided by a reactor designed to create water having an excess of hydronium ions; and
(iii) said wet wipe being packaged in a water tight sealed inert package prior to use.

2. A method for providing a wet wipe in accordance with claim 1 wherein the water has a pH ranging between about 2.8 and 3.8.

3. A method in accordance with claim 1 wherein the low pH water is prepared using a water having excess Cl ions.

4. A method in accordance with claim 1 comprising agents of other chemistries from the group of; scents, perfumes, surfactants, buffers, solvents.

5. A wet wipe comprising a fibrous sheet material and a liquid antimicrobial agent affective against bacteria, fungi, yeasts, mold, protozoan, and viruses, wherein said agent having a pH ranging from about 2.0 to about 4.0, wherein said solution is prepared using low pH water from a reactor for creating an excess of hydronium ions in said water.

6. A wet wipe in accordance with claim 5 wherein the pH is approximately 3.0.

7. A wet wipe in accordance with claim 5 wherein the fibrous sheet material is a non-woven polyester material.

8. A wet wipe in accordance with claim 5 further comprising a foil packet for holding a quantity of said wet wipes.

9. A wet wipe in accordance with claim 5 comprising approximately 80 grams of liquid antimicrobial agent for 24 wipes held in the packet.

10. A wet wipe in accordance with claim 5 wherein the antimicrobial agent serves to breakdown protective coatings which envelop the bacteria, fungi, yeasts, mold, protozoan, or viruses.

11. The method in accordance with claim 1 wherein the reactor is electrolytic.

12. The method in accordance with claim 1 wherein no chemical stabilizer is used.

13. The method in accordance with claim 1 wherein the low pH water contains salts.

14. The method in accordance with claim 3 wherein the Cl ions are extracted from salts.
